(19) United States
(12) Patent Application Publication
(10) Pub. No.: US 2012/0209689 A1
(43) Pub. Date: Aug. 16, 2012

(54) Process for viewing electronic content potentially at no cost to consumers in exchange for viewing imbedded and possibly interactive advertisements

(75) Inventor: Brian Ardle Nolan, Lilburn, GA (US)

(73) Assignee: Mr. Brian Ardle Nolan, Lilburn, GA (US)

(21) Appl. No.: 12/932,003

(22) Filed: Feb. 15, 2011

(51) Int. Cl. G06Q 30/00

(52) U.S. Cl. 705/14.39

(57) ABSTRACT

A structure for creating a facilitator organization to deliver content potentially at no cost to consumers in exchange for viewing advertising that might include an interactive element with the steps of: creating the facilitator organization, by which an entity is created offering intellectual content via any and all available means to the consumer, offering commercial businesses the advertising service, offering intellectual content to the consumer, offering advertising which might include an interactive element to consumers, collecting and distributing revenue by the advertising viewed by the consumers via the Internet or similar means, by which the data is collected and analyzed, by which the advertiser is satisfied that the advertising has reach a specific numerical population of consumers that might include specific demographics that the advertiser has contracted with the facilitator for.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of business method and more specifically to a process for delivering content that can be accessed through a variety of media potentially at no cost to the consumer in exchange for viewing advertisements that could possibly include interactive components embedded in the content.

Advertisement has been used as a means to defray or eliminate the cost of delivering intellectual content in a variety of venues. It began with newspapers. Advertising was imbedded within the pages of the content. Businesses would pay the newspaper publishers to insert blocks of advertising in the body of the pages or to include inserts that delivered a message to entice consumers to do business with the advertiser. Radio and television would eliminate the cost of their content and delivery by presenting advertising messages from businesses and having the advertiser completely pay for the process. Both of these marvels were made available because the government made airwave spectrum available to the industries. The fact that the public had no financial outlay beyond the cost of the receiver caused the industries to flourish. Recent decades have brought many innovations to the home entertainment industry. These additional advances however come with financial cost to the public. There are myriad companies that compete with each other to garner the public interest in their segment of the industry and solicit the public available disposable income.

Advertisers have sought to use the popularity of the Internet to convey their message. They have positioned their message in various locations around a page of content. They are challenged to divert the customer's interest and concentration to delve into their message. The customer is not under any obligation to view any of the ancillary messages on the pages.

There are schemes to offer credits if a customer views advertising on-line. The schemes are complicated and not widely used because they are cumbersome to set up and put into place. They also require that they get the customer's attention by advertising the advertising venue and establishing value in the mind of the consumer.

There have been some innovations in regard to printed materials. Books can be purchased on external computer storage devices and viewed on electronic devices such as e-readers and computers. They can be downloaded from a remote source on these devices also. Newspapers can be downloaded from a remote source at a cost in the same manner.

Access to the Internet is done on a cost to the consumer basis. The consumer uses some type of personal computer to make use of that access. Much of the content is available to the consumer at no extra charge. However, there is content that requires some sort of fee for use. Another method to receive certain content or delivery methods is to run peripheral advertisement in hopes that the consumer will have some interest and investigate further.

The consumer is being bombarded by content. There are a multitude of content venues that are available. The consumer suffers from over-choice. As the choices have increased, the number of customers frequenting each content venue has decreased. The businesses that are trying to reach the consumer have to splinter their message among more and more venues to reach the same number of potential customers as they did before the entertainment explosion.

As access to more and more materials increased, some traditional venues have begun to suffer. Readership of books and newspapers have been on the decrease. Other venues with easier access have increased as content destinations. E-readers and computers have improved access to books and newspapers but there is a significant cost.

The decrease in readership of newspapers has caused the advertisers that subsidized the cost of publishing a newspaper to decrease the use of that venue. This has sent this application of the written word to be on a downward spiral toward extinction.

Advertisers have turned to more and more outlets for their message. Not only has the message been deluded but advertisers have become less sure about the demographic that they are reaching. They are not sure if their message matches the consumer that they are trying to reach.

### BRIEF SUMMARY OF THE INVENTION

The primary object of the invention is to provide the consumer with content over the internet.

Another object of the invention is to provide the consumer a means to receive content over Internet potentially at no out of pocket cost to the consumer.

Another object of the invention is to allow the consumer the opportunity to receive content over the Internet at no cost in exchange for viewing commercial advertisement.

An object of the invention is to imbed the advertising as part of content or in the same context as the content.

A further object of the invention is to provide consumers the flexibility of view commercials at their discretion.

Yet another object of the invention is to allow the consumer to receive content regardless of time schedule.

Still yet another object of the invention is to allow the consumer to receive content regardless of economic circumstance.

Another object of the invention is to provide the consumer the widest possible options in the content arena.

Another object of the invention is to allow the consumer to specify the content options that interest them.

Yet another object of the invention is to enable the content provider to reach the greatest number of consumers.

Still yet another object of the invention is to remove the disincentive of a purchase price to the consumer in choosing content.

Another object of the invention is to enable the content provider to reach the greatest number of consumers.

A further object of the invention is to broaden access to content.

Yet another object of the invention is to provide the advertiser a guaranteed viewership of their commercials.

Still yet another object of the invention is to enable the advertiser to learn the demographics of the customers they are reaching.

Another object of the invention is to eliminate the need for the advertiser to target a particular time slot.

A further object of the invention is to provide an incentive that reduces negative attitudes towards commercials.

Yet another object of the invention is to allow the customer the option of when to view the advertising to avoid interrupting the content and maximize the consumer's attention.

Another object of the invention is to use interactive modalities via the Internet to confirm the consumer's understanding of the advertising message.

Another object of the invention is to allow the advertiser feedback that can assist them in better construction of the advertising content.

A further object of the invention is to allow the advertiser the ability to present ancillary incentives in the form of coupons, etc.

Yet another object of the invention is to allow content providers to promote their product and content.

Still yet another object of the invention is to remove the disincentive of the cost of the item to the consumer in choosing the product or content.

Another object of the invention is to give the content providers the widest possible revenue base.

Yet another object of the invention is to have the advertiser know exactly who is getting their message.

Other objects and advantages of the present invention will become apparent from the following descriptions, wherein, by way of example, an embodiment of the present invention is disclosed.

In accordance with a preferred embodiment of the invention, there is disclosed a means for presenting advertising messages along with current and other methods of delivering content. Content includes but is not limited to traditionally written materials like books, magazines, and newspapers. There are non-traditional yet current methods for delivering this content to customers. There is the Internet as received by computer devices. There are e-books and similar devices that receive content wirelessly through the Internet or by connecting to a computer. Downloads can be from software devices. Books, magazines, and newspapers can be accessed through purchases using some form of accepted remuneration. The preferred embodiment of the invention would be to offer advertising along with the content. Customers would view the advertising and receive the content at potentially at no cost. In one embodiment, the customer would view the advertising in a conventional means. Another embodiment would call for the customer to engage interactively with the advertising by providing understanding of the message, evaluating the message or the product, or making suggestions about the message or product. Verification that the customer has received the advertising message is passed onto the content provider. Payment is made to the content provider by the advertiser. One embodiment is to have a facilitator that offers the content to the customer and arranges with advertisers to make payment for delivering the advertising messages to customers in return for payment. The facilitator or retailer uses the advertising revenue to pay content providers and retains the residual profit.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### 1. Functional Overview

Setting up an enterprise or adapting a current enterprise that will contract to offer content to customers according to various means described herein. As used herein, the term “content” refers to any intellectual property that can be now or in the future delivered over the Internet or like, yet to be developed, modality. Examples of this include, without limitation, books, magazines, newspaper or any content that can be adapted to this invention. Further examples are the Internet access to the Worldwide Web, Internet usage of streaming video, Internet usage for downloading music, and pay-per-view programming. In general, the content and the delivery of the content need not change. This invention deviates from previous art in that it offers the same product with the intervention of a facilitator or content provider who acts as a middleman between the contracting parties meaning the intellectual content holder, the customer, and the agent wishing to advertise a product or service. The inclusion of the advertiser makes possible the opportunity for the facilitator to charge the advertiser for promoting commercials imbedded in and as a prerequisite for receiving content. The customer views the advertising prior and/or during the delivery of the content. The facilitator verifies viewership of the commercial advertisement and applies the corresponding monetary credit to the consumer's account. The facilitator relays verification of the advertising viewership to the advertising agent who pays the facilitator. The facilitator pays the intellectual property content holder and keeps the residual profit for their service. Hence, customers are not constrained by financial factors in selecting their media options. The content holders have a greater exposure to their intellectual property. Advertisers have a greater opportunity to convey their message to their desired audience.

According to one embodiment, the facilitator contracts with the other parties, meaning the content holder, the advertiser and the customer individually to establish relationships that are a benefit to all. The facilitator arranges for the customer to receive the content of the intellectual property holder potentially, at no out of pocket cost provided they view a prescribed amount of the advertising delivered along with the content on behalf of the advertiser in a method that can be verified. More specifically but without limitation the facilitator offers to the content holder a population of customers. The facilitator pays for the services on behalf of the customer. The facilitator supplies the advertising content, the software programming needed to collect the data, and the information that needs to be collected and formatted.

Furthermore, according to an embodiment, the content holder or agent processes the service order initiated by the facilitator on behalf of the customer. The content holder manages the contract with the facilitator for the service provided to the customer. The content hold or agent makes available the venue within the content that is delivered via, but not limited to, airwaves, satellite, broadband, or cable and Internet connections. The content agent uses the software supplied by the facilitator to transmit and collect data. The content agent will include and transmit the advertising content as designated by the facilitator.

Moreover, according to an embodiment, the facilitator offers a population of potential customers to advertisers at a price determined by the number and, possibly, the demographics of the customer targeted by a particular advertiser. The facilitator receives the capture information from the content agent that summarizes the information pertinent to the customers reached, verification of viewership, the results of interactive communication, and other relevant data. The facilitator processes an order from the advertiser based on the number of customers that they want to reach and, potentially, the demographic specifications that they want to target. The advertiser provides the facilitator with the advertising that they want to run along with the interactive message that they want to deliver. The advertiser may elect to have the facilitator produce the advertising and interactive message. The advertiser will pay the facilitator for the achieved results based on the contracted price.

According to an embodiment, the facilitator and/or the intellectual property holder or agent will solicit or customers who wish to obtain the intellectual property content potentially at no cost to them provided that they meet advertising viewership possibly including an interactive requirement. The facilitator will verify viewership data and collect any interactive messages. The facilitator may collect demographic data in order to make a profile to provide to the advertiser. The customer will agree to pay the facilitator or content agent by keeping some sort of method of payment on file should they not meet the criteria of advertising viewership which could include interactive feedback or provide supplying other information. The customer may be required to give a demographic profile to give to the advertiser as a part of a general population.

Continuing with the description of an embodiment, the content holder delivers the services that they or the facilitator have contracted for on behalf of the customer. The content agent enables the means for the imbedding and the possible interactive facet of the advertising obligation. Thus, the content holder delivers the advertising message to the customer. Any delivery of the content could be the responsibility of the content agent or the facilitator. The customer views the advertising and my respond to an interactive presentation of the advertising message. This enables the intellectual property agent to complete its obligation to the facilitator and receive compensation.

Finally in an embodiment, the advertiser is indirectly responsible for the content enjoyed by the customer. They supply the facilitator and the content agent with the message and interactive requirements that allow them to be compensated for delivery of the information contained in the message. The customer allows themselves to be informed by the products and services by the advertiser. They confirm an awareness or understanding of the message, product or service through the content agent and the facilitator so that the advertiser can compensate them for the content.

### 2. Alternate Functional Overview

An enterprise that contracts to offer media to customer according to an alternate embodiment described herein. In general, the facilitator is the intellectual property content holder or agent who offers content to the customer. This can happen but is not limited to a contractual alliance between the inventor and a content holder or the inventor can establish himself in that role by combining the structures of facilitator and content agent. The facilitator/agent establishes the means to deliver the content to the customer. They also directly deliver the advertising message and collect the feedback from the customer. In all other ways, the embodiment is similar to the previously described embodiment.

According to one embodiment, the facilitator/agent gives information retrieved from advertising viewership and interactive data by the customer along with a possible summary of demographic data. No specific customer information would be revealed except at the customer's request. The advertiser would produce a commercial message along with an information request if there is an interactive element of the ad. The advertiser would specify to the facilitator/agent if a demographic representation of a specific customer base is requested. The advertiser would request the total number of customer households they want to receive the message. The advertiser would compensate the facilitator/agent for the results based on an agreed upon price. The price would vary if specific demographics were sought, the nature of any interactive data that might be received, and the amount of time viewed.

Furthermore, according to an embodiment, the facilitator/agent would offer content as the intellectual content agent to the customer. The facilitator/agent would contract for and package content as requested by the customer. The facilitator/agent would deliver and collect the message and possible interactive data supplied by the advertiser. The customer would contract with the facilitator/agent for content that they wished to receive. They would agree to pay a market price. In lieu of the monetary price, the customer would agree to view a specific amount of advertising that could include an interactive variety. The customer would provide any information requested by the advertiser to be collected by the facilitator/agent. The customer might be required to give the facilitator/agent demographic data on a confidential basis to supply the advertiser with a choice of recipients base on their need.

### 3. Definitions

The facilitator refers to the inventor and/or an authorized agent who employees the use of the invention. Its function is to coordinate the relationships between the other parties in various embodiment of the invention. The facilitator/agent is the inventor and/or and authorized agent in an alternate embodiment of the invention where the facilitator/provider performs a dual role of the facilitator and an agent for the intellectual content holder. The advertiser is a general description of any, not limited to, company or individual who seeks the benefit of making their product or service know to the public. The customer is any member of the public at-large who has the need or desire for the content available through the facilitator and to whom the advertiser would wish to reach with their message. The intellectual property holder or agent consists of but is not limited to those who provide books, magazines, newspapers, music, etc. Content is represented by the aforementioned that can be delivered by but not limited to cable, satellite, broadband, public airwaves, and the Internet. It can be received over the personal computers, e-readers, iPads, iPhones, Blackberrrys, and all personal electronic devices.

### 4. A Typical Relationship Structure

An approach for setting up an enterprise which contracts to offer intellectual content is according to one embodiment described herein. There are several relationships, but it is not limited to these relationships, that may be involved in an embodiment of the invention. The facilitator coordinates the services that would allow the plan to be viable in a variety of circumstances. It would consist of individual or a menu of intellectual content that would satisfy the needs of the customer and the advertiser. The facilitator would arrange with agents who offer intellectual property that is delivered electronically or contained in software. Currently, there are venues that offer this intellectual content via this present means of delivery. The facilitator would solicit advertisers that would be interested in exposure to the customer base that could be serviced by a facilitator. At the same time, the facilitator would solicit customers with the offer of potentially free intellectual property content if they view advertising which may include an interactive component.

In an embodiment, the facilitator offers a population of potential customers to the advertiser at a price determined by the number and might include a demographic aspect of customers that they wish to reach. The facilitator captures information as to which customers were successfully reached. This may include the results of the interactive communication and any other aspect of retrieved data. The facilitator receives an order from the advertiser based on the number of customers that they want to reach and may include demographic specifications they want to target. The advertiser supplies the facilitator with the advertising content that they want to run possibly including the interactive message that they want a response for. The advertiser may elect to have the facilitator produce the advertising content and/or an interactive message. The advertiser will pay the facilitator for the achieved results based on the contracted price.

### 5. Dual Roles for the Facilitator

There is an approach for setting up an enterprise that contracts to offer media to customers according to an alternate embodiment described herein. This is an embodiment where the facilitator would perform the role as described herein but would also perform the role of the intellectual property holder or agent. The facilitator would become the facilitator/agent. The facilitator/agent would pursue contractual arrangements to secure access to the content without limit as to the method of delivery.

In an embodiment, the facilitator/agent would offer a population of potential customers to the advertiser at a market price determined by the number and possible demographics of the customer profile that the advertiser wishes to reach. The facilitator/agent captures information as to which customers were successfully reached, the possible results of the interactive communication and any other aspect of the received data. The facilitator/agent receives an order from the advertiser based on the number of customers that they wish to reach and the possible demographic specifications that they want to target. The advertiser supplies the facilitator/agent with the advertising content that advertiser wants to run along with a possible interactive message that they want to deliver. The advertiser may elect to have the facilitator/agent to produce the commercial content and/or an interactive message. The advertiser will pay the facilitator/provider for achieved results based on the contracted price.

In another feature of an embodiment, the facilitator/agent would solicit for customers who wish to engage a service that will provide them with a variety of content at no charge to them provided that they meet the advertising viewership requirement with a possible interactive component. The facilitator/agent might collect demographic data in order to make a profile to give to the advertiser. The customer will contract with the facilitator/agent to supply a selection of content from a menu or library. In an embodiment, the basic service would include, but not limited to, selections of books, magazines, newspapers, music, or other intellectual property. The customer would agree to pay a market price in currency or other method of payment for the product should they not meet the advertising requirement which might include interactive viewership. The customer would agree to watch the designated number of minutes of advertising including an interactive option which would correspond to the value place on the intellectual property content that they select. The customer may be required to answer interactive questions or provide other information requested. The customer could be required to give demographic information to the facilitator/agent that is deemed necessary to form a demographic profile to give to the advertiser as part of a general population of potential commercial targets.

Furthermore in an embodiment, the facilitator/agent would contract with the various entities that produce content. The content could be packaged in the same form as the material is currently offered and offered to the customer by the facilitator/agent.

### 6. Advertising Steps

There is a segment of an approach for setting up an enterprise that contract to offer media to customers according to one embodiment described herein. There is a segment of an operation that begins with the solicitation of the advertisers to produce and pay the facilitator based on advertising viewership that may include an interactive component included in the content. The facilitator contracts with various advertisers that seek to have the public view their message regarding their products or services. The advertiser produces a commercial advertising message with possible interactive request for information in the body of the commercial or as a tag at the end. The advertiser may select a demographic that they wish to reach. The facilitator instructs the content provider on which advertising messages to include or imbed based on the number the advertiser requests or the possible demographics selected. Each item of content would have an identifier that related to the customer to which the content was delivered and received. The customer would view the advertising message. The customer responds to interactive information if requested. If the information is satisfactory, the customer is notified as to the credit received. The data is collected on software that the facilitator has supplied to the content agent. The content agent gives the information to the facilitator. The facilitator compiles the data, summarizes it and gives it to the advertiser. The advertiser compensates the facilitator according to a contractual agreement. The facilitator distributes the funds to itself and the content agent on behalf of the customer. An embodiment of this segment of the process is completed.

### 7. Steps for Receiving Service

A segment of an approach for setting up an enterprise that contracts to offer content to customers according to one embodiment described herein. It is an operation for delivering content to the customer. The agreement states that the customer will be responsible for the market cost of the content in equivalent advertising minutes of commercial viewership which might include an interactive component. The facilitator offers a selection of content to the customer. The customer makes a selection that suits them which includes advertising along with possible interactive aspects. The customer contracts with the facilitator, the intellectual property agent, or the facilitator/agent for specific content to be received. The facilitator makes arrangement with the various content agents responsible for the chosen services. The services are delivered to the customer from a variety of means as deemed appropriate by the customer. An embodiment of this segment of the process is completed.

8. Steps for Contracting with Intellectual Property Content Holders or Agents

A segment of an approach for setting up an enterprise that contracts to offer content to customers according to one embodiment described herein. There is a segment of an operations that contracts with intellectual property content holders or agents. The customer selects content. It may be individual or part of a menu of content. The facilitator would contract with the content holder. The facilitator would negotiate a price with the content holder to use an embodiment of the invention to deliver the content to the customer along with the advertising message that might include an interactive portion of the commercial. The content holder or agent would deliver the content and advertising to customers using an existing business process. The facilitator would supply the content holder or agent with software to collect and sort the data from the advertising viewership and possible interactive portions. The content holder or agent would collect the data for the facilitator. The facilitator would compensate the content holder or agent for the service to the customer and the collection of the data out of the proceeds from the advertiser. An embodiment of this segment of the process is completed.

9. An Alternate of Steps for Contracting with Intellectual Property Content Holders or Agents

A segment for setting up an enterprise that contracts to offer media to customers according to an alternate embodiment described herein. There is a segment of an operation that describes the facilitator as the content holder or agent. The facilitator/agent would contract with the customer. The facilitator/agent would deliver content or a body of content selected by the customer. The delivery can take place by any available means including, but not limited to, cable, internet, airwaves, broadband, satellite, etc. The customer would have some means of identification that would record and assign credit for watching the advertising that might include an interactive aspect. The advertising might be selected based demographic information of the customer. The facilitator/agent would record the advertising minutes viewed by the customer along with possible responses to interactive question asked as part of the advertising message on software. The data would be summarized so the facilitator/agent could validate the order from the advertiser who would compensate the facilitator/agent based on the results. The facilitator/agent would continue to provide content to the customer as long as they continue with their advertising arrangement. This segment of an embodiment is completed.

10. Steps for Implementing and Embodiment of the Invention

There is an approach for setting up an enterprise that contracts to offer content to customers according to an embodiment described herein. The inventor creates the facilitator organization or combines with another organization to create the facilitator. The facilitator sets up to contract with the elements of the business which include, but are not limited to, customers, the intellectual content holder or agent, and the advertisers. The facilitator contracts with the customer to receive the content at no out of pocket cost if they meet an advertising viewership requirement which might include an interactive requirement equivalent to the cost placed on the services by the facilitator and the value of the interactive viewing placed on it by the facilitator. The facilitator contracts with the content holder who delivers the content to the public. The facilitator contracts with businesses who wish to have an advertising message seen by members of the public. The customer selects the media services that they wish to receive. The customer agrees to pay the equivalent monetary cost of this content. They are assigned some means of identification that might also classify them according to a demographic community that advertisers might wish to reach. The customer would enter an appropriate identifier each time they choose content and the accompanying advertising. Other modes of verification might also be required. Each time the customer views an advertising message, credit goes towards their billing statement so that they have the potential to receive their content at no monetary cost. The facilitator arranges for the content to deliver the services to the customer. The content holder or agent would deliver the advertising including any interactive aspects to the customer via Internet or other means. The facilitator arranges with the advertiser to supply produced commercial message that may include an interactive information request that would be part of the body of the advertising message or a tag on the end. The advertiser might elect to have the facilitator produce and supply the commercial and interactive request. The facilitator would supply the commercial and possible interactive request. The facilitator would supply the software to collect the customer responses and viewing credit. The facilitator would arrange compensation agreements with the content holder for service to the customer. The content holders would supply their services to the customer based on orders they receive directly from the customer or from the facilitator. The content holder would deliver the advertising and interactive requests. The content holder would receive and compile the data from the customer suing software supplied by the facilitator. The content holder would collect the viewership minutes and answers to information if requested in an interactive message to be credited to the customer. They would use the software supplied by the facilitator. The content holder would give the collected data in the form designed into the software by the facilitator. The facilitator would give the data to the advertiser to verity the viewership and possibly the demographics requested. The advertiser compensates the facilitator based on the contracted price for the number of customers, the time the customers view advertising, and a possible demographic component. The facilitator distributes the funds according to the profit model that they set up. The facilitator compensates the content holder for the cost of the content per their negotiated contract. This would complete one embodiment.

An approach for setting up an enterprise which contracts to offer media to customer according to an alternate embodiment described herein. In an embodiment, the inventor creates the facilitator/agent organization or combines with another organization to create the facilitator/agent. The facilitator/provider would act as the agent for the intellectual property holder. The facilitator/agent contracts with the elements of the business which include, but are not limited, to the customer, the Internet and other delivery modes for content, and advertisers. The facilitator contracts with customers to receive media services at no out of pocket costs if they meet the advertising viewership criteria and possible interactive requirements equivalent to the cost placed on the content by the facilitator/provider. The customer selects the content that they wish to receive. The customer agrees to pay the monetary cost of those services if they don't meet the advertising requirements. They are given an identifier that may include demographics that advertisers wish to reach. The customer would use an identifier each time they viewed content and advertising. Other modes of verification might also be required. Each time the customer views and advertising message and the attached content, credit goes towards their billing statement so that they have the potential to receive their content at no monetary cost. A facilitator/agent arranges for their content and the content of other content holders to the customer. A facilitator/agent or other content agent or holder would deliver the advertising including possible any interactive messages to the customer via the content. The facilitator/agent contracts and arranges with the advertiser to supply a commercial message that they have produced along with possible interactive information request either as part of the body of the message or a tag at the end. The advertiser could elect to have the facilitator/agent produce the advertising and message. The facilitator/provider would supply content to the customer based on their contracted order. The facilitator agent would deliver the advertising and interactive request if needed. The facilitator/provider would receive and compile the data from the customer using appropriate software. They would do this over conventional and yet to be invented venues. The facilitator/agent would collect the requested responses from the interactive messages along with the viewing time to be credited to the customer on appropriate software. The facilitator/provider would give the data to the advertiser to verify the viewership and possibly any demographics requested. The advertiser compensates the facilitator/agent based on the contracted price for the contracted number of customers and possible demographic identity. The facilitator/agent compensates the other content agents from the cost of the content per their negotiated contract. This would complete an alternated embodiment.

11. Compensation

The facilitator would negotiate with the intellectual property holder or agent for a price to deliver and maintain their services to the customer. The facilitator would negotiate with the customer for a price to arrange the delivery of content and advertising messages. The facilitator would negotiate a cost to the advertiser for the viewing of advertising that may include interactive components by the customers that could include targeting the customers based on demographics, the minutes watched, and the type of information requested by the advertiser. The facilitator would be paid upon delivery of a summary of the data to the advertiser. The facilitator would collect and distribute all funds according to their profit model. The customer would receive credit for their interactive viewing minutes or pay the contracted price.

### 12. Verification

The facilitator assigns a method to identify a customer and track delivery of content and advertising. Software records the activity and responds with verification that the advertising message was viewed and transmit any response made in an interactive method. The customer would be tracked each time that they accessed content. In an embodiment, the software that manages the download of content would deliver the advertising to a verified address. When the review of the content is completed including viewership of the advertising, a download from the device that received the content and advertising would be required to transmit the verification back to origin of the download of the content and advertising.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A means for creating a facilitator organization for delivering intellectual content potentially at no cost to consumers in exchange for viewing advertising that might include interactive components comprising the steps of:
A means of offering said advertising and content to the consumer;
A means of offering said advertising including interactive options on the behalf of commercial advertisers;
A means of offering said advertising including interactive options to the consumers;
A means of collecting and distributing revenue generated by said advertising, said intellectual property content;
A means of offering an entity for the delivery of intellectual property content;
A means of offering an entity to the commercial advertiser to contract for said services;
A means of creating said facilitator organization;
A means by which said facilitator offer said intellectual content to the consumer potentially at no financial cost;
A means by which said facilitator offer said intellectual content to the consumer in exchange for viewing advertising which might have and interactive aspect via download of intellectual content;
A means by which said facilitator might ask question regarding the advertising on behalf of the advertiser;
A means by which said facilitator will receive data as a result of the consumer's answers;
A means by which said facilitator will receive data via the Internet, a wireless connection, or any other means of content delivery;
A means by which facilitator will include or imbed a selection of advertising messages and possibly related interactive questions;
A means by which said facilitator will contract with intellectual content holders or their agents to include the advertising message and the possibility of related interactive questions;
A means by which said facilitator will contract with the consumer to provide content including a possible menu of such contents;
A means by which said facilitator will contract with the advertiser to provide commercial messages and the option of soliciting interactive data from the consumer;
A means by which said facilitator will provide the consumer with a billing statement that will include the monetary cost of their selected content;
A means by which said facilitator will provide the consumer with a billing statement that will include the number of interactive advertising minutes required to eliminate the financial cost;
A means by which said facilitator will give the consumer a method to identify themselves when procuring content;
A means by which said facilitator might require demographic information that would be targeted by advertisers;
A means by which said facilitator would determine the value of each demographic that might be requested by the advertiser;
A means by which said facilitator will charge the advertiser depending on the value of each demographic;
A means by which said facilitator will include or imbed advertising in content requested by a customer in a certain demographic;
A means by which said facilitator will collect appropriate data to give to the advertiser to determine the effectiveness of the advertiser's exposure;
and A means by which said facilitator will keep a confidential data base of the demographic categories of each customer.
